(19) United States
(12) Patent Application Publication
(10) Pub. No.: US 2013/0136136 A1
(43) Pub. Date: May 30, 2013

(54) APPARATUS AND METHOD FOR PROCESSING RECEIVED DATA

(71) Applicant: FUJITSU LIMITED, Kawasaki-shi (JP)

(72) Inventors: Yoshinori ANDO, Numazu (JP); Norihiko MOCHIZUKI, Fuji (JP); Koji YAMADA, Mishima (JP)

(73) Assignee: FUJITSU LIMITED, Kawasaki-shi (JP)

(21) Appl. No.: 13/686,016

(22) Filed: Nov. 27, 2012

(30) Foreign Application Priority Data
Nov. 28, 2011 (JP) 2011-259442

(51) Int. Cl. H04L 12/54

(52) U.S. Cl. CPC H04L 12/54
USPC 370/395.1; 370/412

(57) ABSTRACT

An apparatus, upon receiving a first data segment, stores, in a processing queue, a data-segment processing request associated with the first data segment. When the data-segment processing request is extracted from the processing queue, the apparatus performs predetermined processing on the first data segment associated with the data-segment processing request to generate a second data segment, and stores the generated second data segment in a reception buffer provided for each of destinations of data segments. The apparatus stores a holding-stop processing request in the processing queue when the second data segment is stored in the reception buffer being empty, and sends all of one or more second data segments stored in the reception buffer, at once, to a destination associated with the reception buffer when the holding-stop processing request is extracted from the processing queue.

### CROSS-REFERENCE TO RELATED APPLICATION

This application is based upon and claims the benefit of priority of the prior Japanese Patent Application No. 2011-259442, filed on Nov. 28, 2011, the entire contents of which are incorporated herein by reference.

### FIELD

The embodiments discussed herein are related to an apparatus and method for processing received data.

### BACKGROUND

Heretofore, in communication using a byte-stream (byte-oriented) communication protocol typified by a TCP (transmission control protocol), upon receiving data, a protocol handler, which performs processing control according to a communication protocol, immediately passes the data to a high-order application.

FIG. 1 is a schematic diagram illustrating an example in which received data is immediately passed to a high-order application. FIG. 1 illustrates an example in which a transmitter 520 divides data to be transmitted into two data segments, namely, data segment 1 and data segment 2, and the two data segments 1 and 2 are sent to a high-order application in a receiver 510 via a protocol handler.

When the protocol handler immediately passes the received data to the high-order application in a receiver 510, the received data are frequently passed between the protocol handler and the high-order application. This causes some problems. Owing to, for example, overhead of processing for passing the received data and received-data assembly processing performed by the high-order application, the processing efficiency is reduced and the amount of load of a CPU (central processing unit) is increased.

In computer systems in recent years, the improvement in the CPU performance is relatively small compared to the dramatic increase in the speeds of networks. Thus, it is desired to reduce the amount of CPU usage in connection with the increase in the amount of data in network communication.

The “byte-stream communication protocol” refers to a communication protocol in which data to be communicated is treated as a string of bytes. In the byte-stream communication protocol, data is divided or coupled together for transmission/reception, regardless of delimiters of units meaningful to the high-order application. Thus, the high-order application is required to assemble or divide the data, passed from the protocol handler, into the meaningful units.

Examples of related art include Japanese National Publication of International Patent Application No. 2002-527945 and Japanese Laid-open Patent Publication No. 2005-143098.

The protocol handler buffers data and passes multiple pieces of data (multiple data segments) to the high-order application at once, thereby making it possible to improve the processing efficiency. Typically, when data having a certain data length is buffered or when a certain amount of time passes after first data is buffered, data that have been buffered up to that time are passed to the high-order application at once.

FIG. 2 is a schematic diagram illustrating an example in which received data are passed to a high-order application when a certain amount of time passes after first data is buffered. In FIG. 2, the protocol handler stores the received data segment in a buffer without immediately passing the data to the high-order application. When a certain amount of time t passes after the first data is received, the protocol handler passes pieces of data, stored in the buffer, to the high-order application at once.

In such buffering, however, sending of data to the high-order application is delayed, which may impair responsiveness. The term “responsiveness” as used herein refers to how small the amount of time is from when data are sent to the high-order application until the high-order application completes the processing of the data. The responsiveness improves as the amount of time from when the data is received until completion of sending the data to the high-order application decreases. In general, the throughput (the amount of processing that is performed on received data by the receiver 510 per unit time) increases, as the responsiveness is improved.

For example, in the example illustrated in FIG. 2, although it is efficient to send the data segments 1 and 2 to the high-order application upon reception of the data segment 2, the sending of the data segments 1 and 2 is delayed until a certain amount of time passes after the data segment 1 is buffered. In the byte-stream communication protocol, it is difficult for the protocol handler to determine whether or not the received data segment is the last data segment of the data. Thus, even when there exist no data segments subsequent to the data segment 2, sending the data segment 2 is waited for a certain amount of time.

As a result of the waiting for the certain amount of time, the received data segments are accumulated in the buffer in the protocol handler, which may affect the flow control of the data communication and may cause buffer exhaustion.

### SUMMARY

According to an aspect of the invention, an apparatus, upon receiving a first data segment, stores, in a processing queue, a data-segment processing request associated with the first data segment. When the data-segment processing request is extracted from the processing queue, the apparatus performs predetermined processing on the first data segment associated with the data-segment processing request to generate a second data segment, and stores the generated second data segment in a reception buffer provided for each of destinations of data segments. The apparatus stores a holding-stop processing request in the processing queue when the second data segment is stored in the reception buffer being empty, and sends all of one or more second data segments stored in the reception buffer, at once, to a destination associated with the reception buffer when the holding-stop processing request is extracted from the processing queue.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an example in which received data is immediately passed to a high-order application;

FIG. 2 is a schematic diagram illustrating an example in which received data are passed to a high-order application when a certain amount of time elapses after data is buffered:

FIG. 3 is a diagram illustrating a configuration example of a communication system, according to an embodiment;

FIG. 4 is a diagram illustrating an example of a hardware configuration of a receiver, according to an embodiment;

FIG. 5 is a diagram illustrating an example of a functional configuration of a receiver, according to an embodiment;

FIG. 6 is a diagram illustrating an example of an operational sequence performed by a receiver, according to a first embodiment;

FIG. 7 is a diagram illustrating an example of states of a processing queue and a reception buffer, according to an embodiment;

FIG. 8 is a diagram illustrating an example of states of a processing queue and a reception buffer, according to an embodiment;

FIG. 9 is a diagram illustrating an example of states of a processing queue and a reception buffer, according to an embodiment;

FIG. 10 is a diagram illustrating an example of states of a processing queue and a reception buffer, according to an embodiment;

FIG. 11 is a diagram illustrating an example of an operational sequence executed by a receiver, according to a first embodiment;

FIG. 12 is a diagram illustrating an example of states of a processing queue and a reception buffer, according to an embodiment;

FIG. 13 is a diagram illustrating an example of states of a processing queue and a reception buffer, according to an embodiment;

FIG. 14 is a diagram illustrating an example of an operational flowchart for receiving a data-segment processing request, according to a first embodiment;

FIG. 15 is a diagram illustrating an example of processing requests stored in a processing queue, according to a first embodiment;

FIG. 16 is a diagram illustrating an example of a received data segment before protocol processing is executed, according to an embodiment;

FIG. 17 is a diagram illustrating an example of an operational flowchart for processing a processing request, according to a first embodiment;

FIG. 18 is a diagram illustrating an example of a reception buffer, according to an embodiment;

FIG. 19 is a diagram illustrating an example of an operational flowchart for processing a processing request, according to a second embodiment;

FIG. 20 is a diagram illustrating an example of a reception buffer, according to a second embodiment;

FIG. 21 is a diagram illustrating an example of states of a processing queue and a reception buffer, according to a third embodiment; and

FIG. 22 is a diagram illustrating an example of an operational flowchart for processing a processing request, according to a third embodiment.

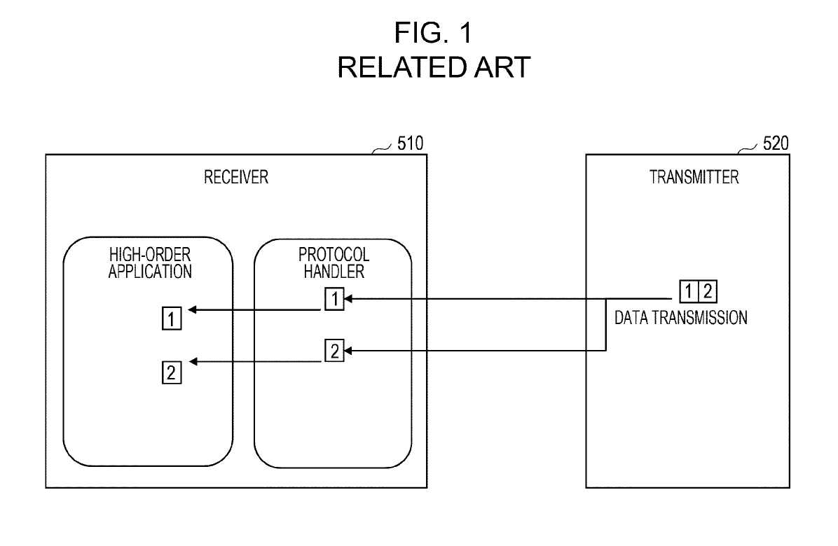

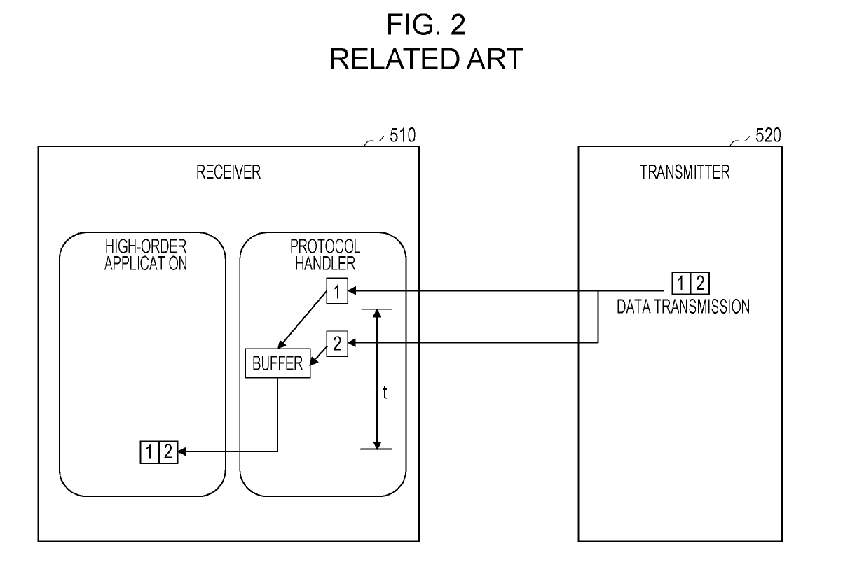

### DESCRIPTION OF EMBODIMENTS

An embodiment of the present technology will be described below with reference to the accompanying drawings.

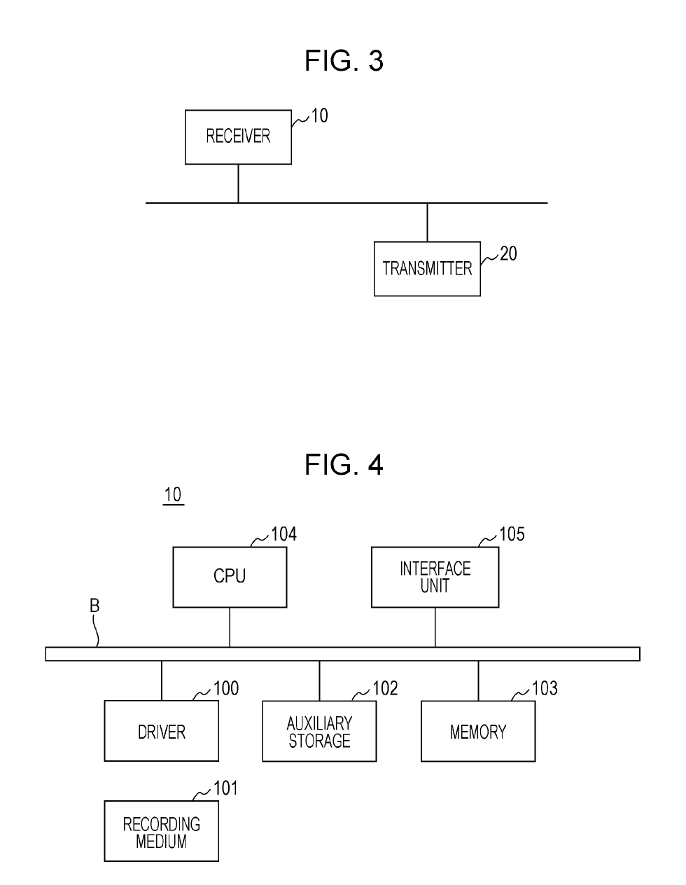

FIG. 3 is a diagram illustrating a configuration example of a communication system, according to an embodiment. In FIG. 3, a transmitter 20 and a receiver 10 are able to communicate with each other through a network, such as a LAN (local area network) or the Internet. The network may be partly or entirely implemented by wireless communication.

The transmitter 20 is an information processing apparatus for transmitting data to the receiver 10. The receiver 10 is an information processing apparatus for receiving data transmitted from the transmitter 20. In the embodiment, a TCP (transmission control protocol), which is one example of a byte-stream (byte-oriented) communication protocol, is used for data communication between the transmitter 20 and the receiver 10. However, a byte-stream communication protocol other than the TCP may also be used.

Therefore, data to be transmitted from the transmitter 20 to the receiver 10 is divided into data segments for transmission. The term “data segments” refer to data divided for transmission. For example, an IP header and a TCP header are given to each data segment. When transmission data fit into one data segment, the transmission data are treated as one data segment without being divided.

The names of the transmitter 20 and the receiver 10 are used merely for convenience of description. That is, the transmitter 20 may serve as a data-receiving side and the receiver 10 may serve as a data-transmitting side, depending on progress of a communication procedure.

FIG. 4 is a diagram illustrating an example of a hardware configuration of a receiver, according to an embodiment. The receiver 10 illustrated in FIG. 4 may include a driver 100, an auxiliary storage 102, a memory 103, a central processing unit (CPU) 104, and an interface unit 105, which are interconnected through a bus B.

A program for realizing processing of the receiver 10 is provided using a recording medium 101. When the recording medium 101 on which the program is recorded is set in the driver 100, the program is read from the recording medium 101 via the driver 100 and is installed to the auxiliary storage 102. The program, however, may or may not be installed using the recording medium 101. For example, the program may be downloaded from another computer through a network. The auxiliary storage 102 stores therein files, data, and so on in conjunction with the installed program.

In response to a program startup instruction, the memory 103 reads program from the auxiliary storage 102 and stores the program therein. The CPU 104 executes functions of the receiver 10 in accordance with the program stored in the memory 103. The interface unit 105 is, for example, a network card and is used as an interface for connection to the network.

One example of the recording medium 101 is a portable recording medium, such as a CD-ROM (compact disc-read only memory), a DVD (digital versatile disc), or a USB (universal serial bus) memory. One example of the auxiliary storage 102 is a HDD (hard disk drive) or a flash memory. The recording medium 101 and the auxiliary storage 102 are each considered as a computer-readable recording medium.

The transmitter 20 may also have a hardware configuration as illustrated in FIG. 4.

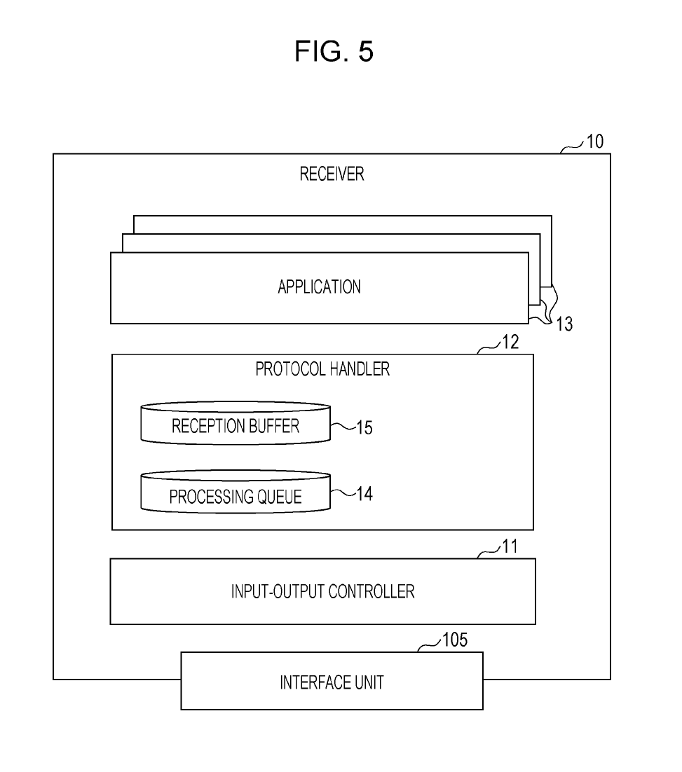

FIG. 5 is a diagram illustrating an example of a functional configuration of a receiver, according to an embodiment. In FIG. 5, the receiver 10, for example, includes an input-output controller 11, a protocol handler 12, and one or more applications 13.

The input-output controller 11 reads out received data, received by the interface unit 105, from the interface unit 105. The input-output controller 11 outputs, for each data segment, a request for processing the each data segment to the protocol handler 12. Herein after, “a request for processing a data segment” will be also expressed as “a data-segment processing request.

The received data is stored in a memory in the interface unit 105 until the received data is read out by the input-output controller 11. For example, an input-output controller 11a may be realized by causing the CPU 104 to execute program, installed in the receiver 10, that serves as a device driver for the interface unit 105. Hereinafter, received data for each data segment is referred to as a “received data segment” or abbreviated as a “data segment”.

In response to a data-segment processing request from the input-output controller 11, the protocol handler 12 executes processing on the received data segment associated with the data-segment processing request, according to a communication protocol (TCP). The processing that complies with the communication protocol is hereinafter referred to as “protocol processing”. Examples of the protocol processing include analysis processing of an IP header and analysis processing of the TCP header. The protocol processing involves, for example, identification of a destination (connection), checking of the presence/absence of a falsification, and determination of correctness/incorrectness of a reception order. The destination is identified based on the IP address included in the IP header and a port number included in a TCP header. In the embodiment, one application 13 is assumed to have one connection. That is, as a result of the identification of the destination, the application 13 to which a received data segment is to be sent (or transmitted) is identified. The checking of the presence/absence of a falsification is performed using, for example, an IP check sum and a TCP check sum. The correctness/incorrectness of the reception order is determined based on, for example, a sequence number and an ACK number.

The protocol handler 12 utilizes storage units, such as a processing queue 14 and a reception buffer 15. The processing queue 14 is a storage unit that stores therein processing requests, received from the input-output controller 11, on a FIFO (first-in first-out) basis. The reception buffer 15 is a storage unit that stores therein, of all the received data segments corresponding to the processing requests stored in the processing queue 14, the received data segment(s) on which the protocol processing has been executed. The processing queue 14 is common to multiple destinations (connections), whereas the reception buffer 15 is provided for each destination (connection). The received data segments stored in the reception buffer 15 are sent, at a predetermined timing, to the application 13 that is the destination with which the reception buffer 15 is associated. The processing queue 14 and the reception buffer 15 may be implemented, for example, using the memory 103.

The protocol handler 12 may be realized by a process which the program installed in the receiver 10 causes the CPU 104 to execute.

In the embodiment, the application 13 is a program that is the destination of data transmitted from the transmitter 20. The application 13 uses, for example, the received data to execute predetermined processing.

An operational sequence executed by the receiver 10 will now be described.

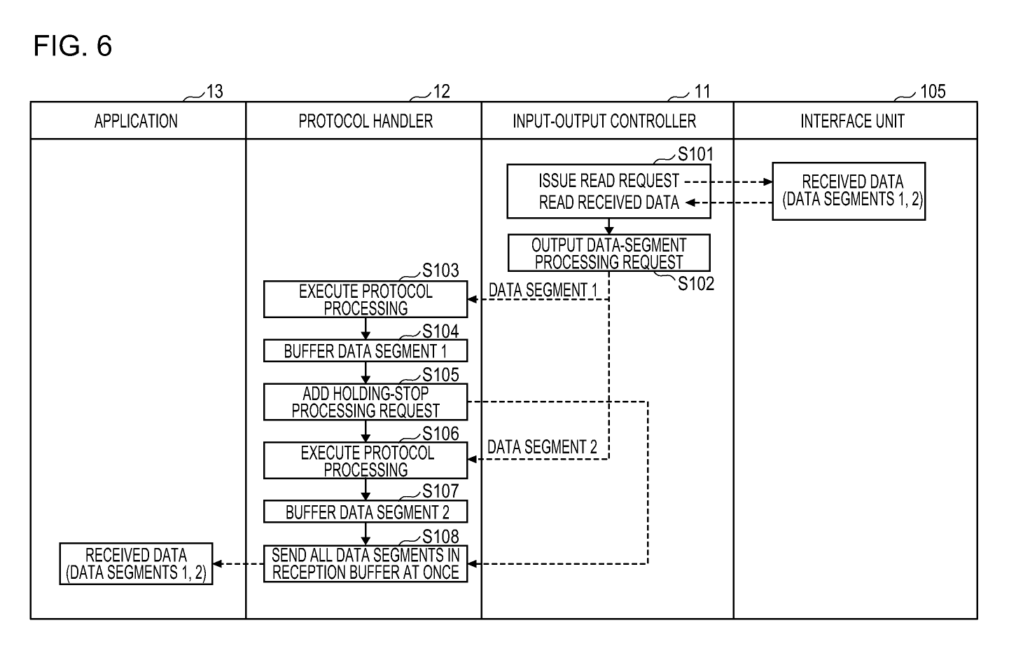

FIG. 6 is a diagram illustrating an example of an operational sequence performed by a receiver, according to a first embodiment.

In operation S101, when the interface unit 105 receives data, the input-output controller 11 issues a read request to the interface unit 105 to read the received data therefrom. In this case, it is assumed that the received data is composed of two received data segments. In this case, the two data segments are read. Typically, when data for N data segments are transmitted from the transmitter 20, multiple data segments less than N data segments are received at once. In this case, N is 2 or more.

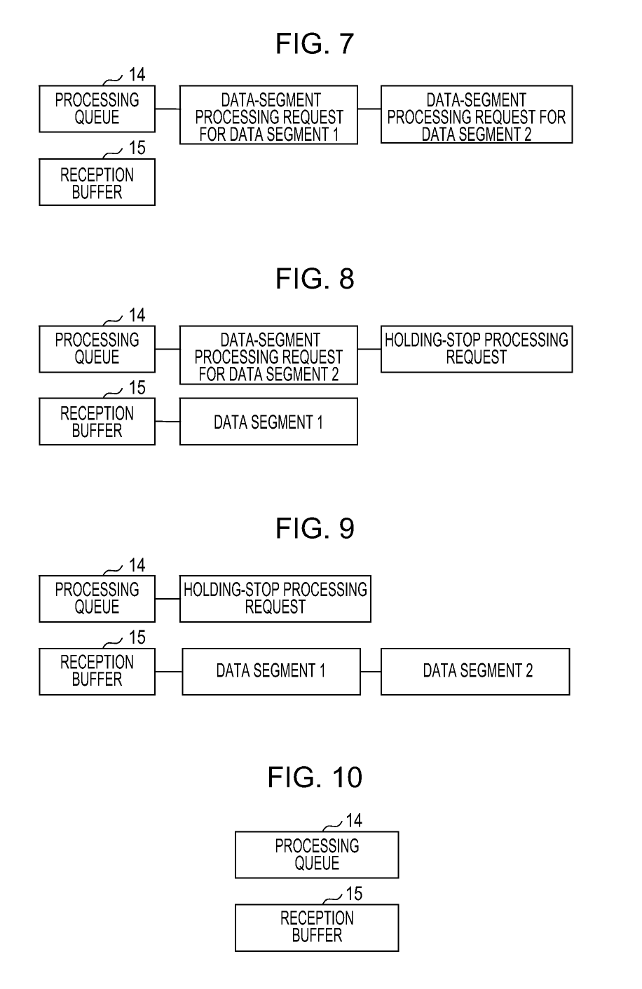

In operation S102, the input-output controller 11 outputs requests for processing the data segments to the protocol handler 12 in order of reception (in order of reading) of the received data segments. Herein after, “a request for processing a data segment” will be also expressed as “a data-segment processing request. The data-segment processing requests are registered in the processing queue 14 in the protocol handler 12. Immediately after the execution of the processing of operation S102, the processing queue 14 and the reception buffer 15 enter, for example, states as illustrated in FIG. 7.

FIG. 7 is a diagram illustrating an example of states of a processing queue and a reception buffer, according to an embodiment. In FIG. 7, the processing queue 14 stores therein a data-segment processing request for a first data segment (a data segment 1) and a data-segment processing request for a second data segment (a data segment 2). On the other hand, the reception buffer 15 is empty.

In operation S103 of FIG. 6, the protocol handler 12 extracts the data-segment processing request for the data segment 1, which is a processing request being at the head of the processing queue 14, and executes, as a predetermined processing, protocol processing on the data segment 1 in response to the extracted data-segment processing request. At the same time, the extracted data-segment processing request is deleted from the processing queue 14.

In operation S104, the protocol handler 12 stores, in the reception buffer 15 associated with the destination of the data segment 1, the data segment 1 on which the protocol processing has been executed.

In operation S105, since the reception buffer 15 has been empty before the data segment 1 is stored in the reception buffer 15, the protocol handler 12 adds a holding-stop processing request to the processing queue 14. Here, the holding-stop processing request is a request for stopping buffering (or, for stopping holding) of the data segments in the reception buffer 15. Stopping of buffering of the data segments in the reception buffer 15 means sending all the data segments stored in the reception buffer 15, at once, to the application 13 that is the destination thereof.

Immediately after the execution of the processing of operation S105, the processing queue 14 and the reception buffer 15 enter, for example, states as illustrated in FIG. 8.

FIG. 8 is a diagram illustrating an example of states of a processing queue and a reception buffer, according to an embodiment. In FIG. 8, the data-segment processing request for the already processed data segment 1 has been deleted from the processing queue 14, the data segment 1 is stored in the reception buffer 15, and the holding-stop processing request is added to the end of the processing queue 14.

In operation S106 of FIG. 6, the protocol handler 12 extracts a processing request being currently at the head of the processing queue 14, that is, a data-segment processing request for the data segment 2, and executes, as a predetermined processing, protocol processing on the data segment 2 in response to the extracted data-segment processing request.

In operation S107, the protocol handler 12 stores, in the reception buffer 15 associated with the destination of the data segment 2, the data segment 2 on which the protocol processing has been executed. In this example, the destination of the data segment 2 is assumed to be the same as the destination of the data segment 1. Thus, the data segment 2 is stored in the same reception buffer 15 as the reception buffer 15 in which the data segment 1 has been stored. In this way, a reception buffer 15 is provided for each of destinations of received data (received data segments), for example, for each of applications 13. In the case, the reception buffer 15 is not empty before the data segment 2 is stored in the reception buffer 15. That is, the data segment 1 has been already stored in the reception buffer 15. Therefore, the protocol handler 12 does not add a holding-stop processing request to the processing queue 14.

Immediately after the execution of the processing of operation S107, the processing queue 14 and the reception buffer 15 enter, for example, states as illustrated in FIG. 9.

FIG. 9 is a diagram illustrating an example of states of a processing queue and a reception buffer, according to an embodiment. In FIG. 9, the data-segment processing request for the already processed data segment 2 has been deleted from the processing queue 14 and the data segment 2 is stored in the reception buffer 15 together with the data segment 1.

In operation S108, the protocol handler 12 sets, as a processing target, the holding-stop processing request that is currently at the head of the processing queue 14. In response to the holding-stop processing request set as the processing target, the protocol handler 12 sends all the data segments stored in the reception buffer 15, at once, to the application 13 that is the destination associated with the reception buffer 15.

Immediately after the execution of the processing of operation S108, the processing queue 14 and the reception buffer 15 enter, for example, states as illustrated in FIG. 10.

FIG. 10 is a diagram illustrating an example of states of a processing queue and a reception buffer, according to an embodiment. In FIG. 10, both of the processing queue 14 and the reception buffer 15 are empty.

According to the operational sequence illustrated in FIG. 6, the received data including the data segment 1 and the data segment 2 may be sent to the application 13, at once, without occurrence of latency. Since all of the buffered data segments are sent to the application 13 at once, the number of times data are passed between the application 13 and the protocol handler 12 may be reduced. As a result, reduction in responsiveness due to the buffering may be reduced and an increase in the amount of load of the CPU 104 may be suppressed. In addition, increase in the amount of load of the CPU 104 may also be suppressed for the reason that timer setting for latency is not performed.

Although an example in which two data segments are sent to the application 13 at once has been described above for convenience of explanation, there is a high possibility, under normal conditions, that data-segment processing requests for a larger number of data segments are collectively stored in the processing queue 14. In particular, when the input-output controller 11 performs buffering, there is a high possibility that two or more data-segment processing requests are stored in the processing queue 14. This means that there is a high possibility that a holding-stop processing request is added to the processing queue 14 for each set of two or more received data segments. As the number of data-segment processing requests that are collectively stored in the processing queue 14 increases, the advantage of enhancing the processing efficiency using the holding-stop processing request increases.

However, there are also cases in which multiple data segments are not received collectively, depending on the state of the load of the network. Accordingly, a description will be given of an operational sequence when a delay occurs during transfer of the data segment 2.

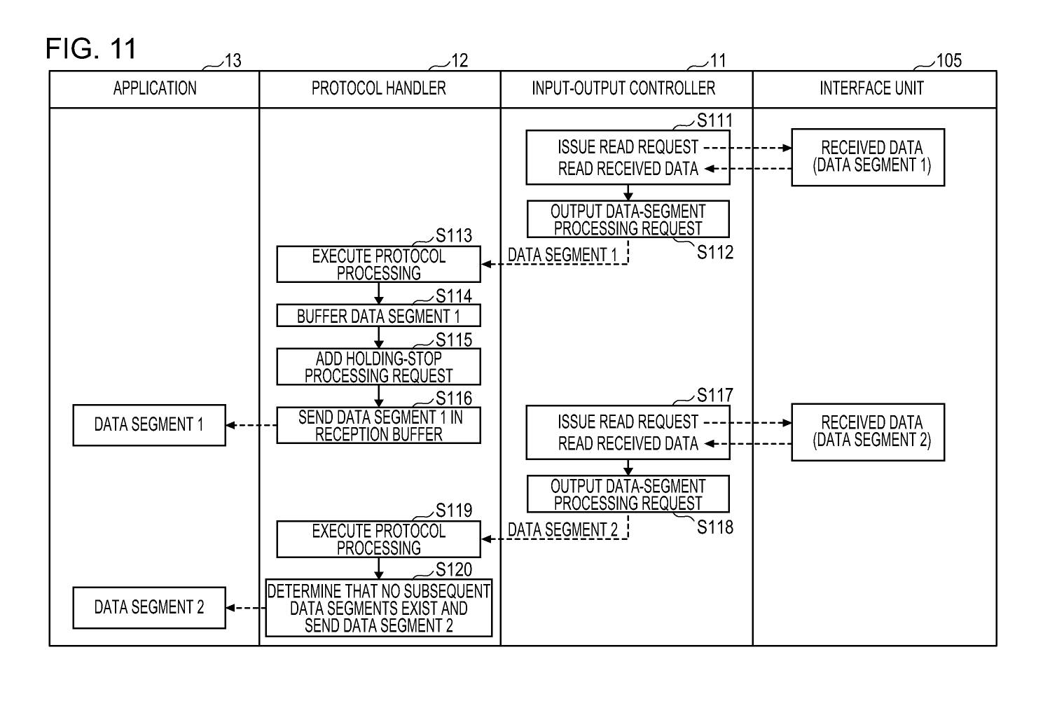

FIG. 11 is a diagram illustrating an example of an operational sequence executed by a receiver, according to a first embodiment.

In operation S111, the input-output controller 11 reads data segment 1 received by the interface unit 105.

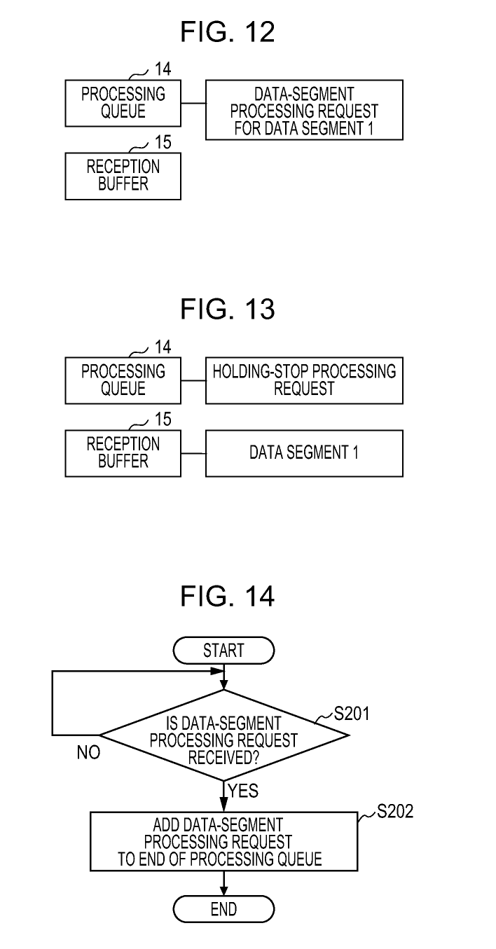

In operation S112, the input-output controller 11 outputs a data-segment processing request for the data segment 1 to the protocol handler 12. Immediately after the execution of the processing of operation S112, the processing queue 14 and the reception buffer 15 enter, for example, states as illustrated in FIG. 12.

FIG. 12 is a diagram illustrating an example of states of a processing queue and a reception buffer, according to an embodiment. In FIG. 12, only a data-segment processing request for the data segment 1 is stored in the processing queue 14 and the reception buffer 15 is empty.

In operation S113 of FIG. 11, the protocol handler 12 extracts a processing request being at the front of the processing queue 14, that is, the data-segment processing request for the data segment 1, and executes, as a predetermined processing, protocol processing on the data segment 1 in response to the extracted data-segment processing request.

In operation S114, the protocol handler 12 stores, in the reception buffer 15 associated with the destination of the data segment 1, the data segment 1 on which the protocol processing has been executed.

In operation S115, since the reception buffer 15 has been empty before the data segment 1 is stored in reception buffer 15, the protocol handler 12 adds a holding-stop processing request to the processing queue 14.

Immediately after the execution of the processing of operation S115, the processing queue 14 and the reception buffer 15 enter, for example, states as illustrated in FIG. 13.

FIG. 13 is a diagram illustrating an example of states of a processing queue and a reception buffer, according to an embodiment. In FIG. 13, the processing request for the already processed data segment 1 has been deleted from the processing queue 14, the data segment 1 is stored in the reception buffer 15, and the holding-stop processing request is added to the processing queue 14.

In operation S116, the protocol handler 12 sets, as a processing target, the holding-stop processing request that is currently at the head of the processing queue 14. When extracting the holding-stop processing request from the processing queue 14, the protocol handler 12 sends the data segment 1 stored in the reception buffer 15 to the application 13 that is the destination of the data segment 1.

Thereafter, in operation S117, when data segment 2 is received, the input-output controller 11 reads the data segment 2 from the interface unit 105.

In operation S118, the input-output controller 11 outputs a data-segment processing request for the data segment 2 to the protocol handler 12. Thus, the data-segment processing request for the data segment 2 is stored in the processing queue 14.

In operation S119, the protocol handler 12 extracts a processing request being at the head of the processing queue 14, that is, the data-segment processing request for the data segment 2, and executes, as a predetermined processing, protocol processing on the data segment 2 in response to the extracted data-segment processing request.

In operation S120, when the protocol handler 12 determines that no subsequent segments exist, based on the segment length of the data segment 2, the protocol handler 12 immediately sends the data segment 2 to the application 13 that is the destination thereof, without storing the data segment 2 in the reception buffer 15. Accordingly, latency due to the buffering does not occur and overhead due to the buffering may also be reduced. The term “subsequent segment” refers to a data segment that is contained in the same data as the already received data segment and in the process of being transferred in the network after being transmitted from the transmitter 20, a data segment that is contained in the same data as the already received data segment and is to be transmitted from the transmitter 20 from now, and so on. The term “same data” refers to data between delimiters meaningful to the application 13.

The determination of the presence/absence of a subsequent segment based on the segment length is also made with respect to the data segment 1 illustrated in FIG. 11. In this case, it is assumed that the absence of a subsequent segment was not presumable with respect to the data segment 1. Therefore, the data segment 1 is stored in the reception buffer 15.

As illustrated in FIG. 11, when a delay occurs between data segments, holding-stop processing requests for respective received data segments are added to the processing queue 14 and the received data segments are sent to the application 13 one by one. Consequently, the occurrence of latency time due to the buffering may be inhibited, but the data passing between the application 13 and the protocol handler 12 occurs frequently. In the embodiment, however, improvement in responsiveness due to immediate sending of received data segments is deemed to be more important than increase in load due to sending of received data segments. In addition, since the processing is being delayed, increase in load due to the frequent occurrence of sending of received data segments is deemed to be considerably small compared to a case in which the processing is not delayed.

In the embodiment, as described above in operation S120, the protocol handler 12 determines the presence/absence of a subsequent segment based on the length of a data segment to be processed. With this arrangement, when no buffering is to be performed, for example, when data that fit into one data segment (not multiple data segments) are received, overhead due to the buffering may be avoided.

Next, a description will be given of one example of a method for determining the presence/absence of a subsequent segment based on the segment length.

In many TCP/IP implementations, a maximum segment size (MSS) is set so that a data segment is not divided when the data segment is transmitted on a transmission path. The MSS is a value obtained by subtracting the IP header size and the TCP header size from a maximum transmission unit (MTU) indicating the maximum length of data that is allowed to be transmitted through a transmission path. When transmitting data whose length exceeds the MSS, the transmitter 20 divides the data into data segments each having length not exceeding the MSS and transmits the divided data segments to the transmission path. The receiver 10 directly receives the divided data segments. Therefore, when the size (the segment length) of a received data segment is equal to the MSS, it is highly likely that a subsequent segment exists because there is a high probability that the length of the last data segment of the same data is smaller than the MSS. Accordingly, when the length of a received data segment is equal to the MSS, the protocol handler 12 determines or estimates that a subsequent segment exists and executes buffering processing.

In some TCP implementations, there are cases in which a received data segment whose length is larger than the MSS is processed after the protocol processing. The processing on a data segment whose length is larger than the MSS is performed in the case where multiple data segments are processed at once under TCP order control of the receiver 10 when the order of data segments is reversed in the network or when a data segment is re-transmitted due to data segment loss. Therefore, there is a possibility that a subsequent segment exists also when a received data segment whose length is larger than the MSS is processed. Accordingly, the protocol handler 12 performs buffering processing also when a received data segment whose length is large than the MSS is processed.

On the other hand, when the length of a received data segment is smaller than the MSS, it is highly likely that the received data segment is a data segment on which transmitter 20 has not performed segment-dividing processing, and thus it is highly likely that no subsequent segments exist. Accordingly, when the length of the received data segment is smaller than the MSS, the protocol handler 12 determines or estimates that no subsequent data segments exist, and does not execute buffering processing.

There are also cases in which the size of a data segment transmitted by the transmitter 20 matches the maximum segment size. In such cases, the receiver 10 may determine that a subsequent segment exists although no subsequent segment exists in practice. Thus, in this case, buffering processing is performed. However, it is highly likely that, subsequent to a data-segment processing request associated with the data segment, a holding-stop processing request is added to the processing queue 14. Thus, the data segment may be immediately sent to the application 13.

In the TCP communication, the value of the MSS is determined by negotiation between the receiver 10 and the transmitter 20 during establishment of a connection (during initiation of a communication) and is set to the TCP headers of a connection-establishment request and a connection-establishment response. Thus, the protocol handler 12 may obtain the MSS from the TCP header and store the MSS in, for example, the memory 103.

When a TCP option, such as a timestamp option, is used, the transmitter 20 divides data into segments each having a size obtained by subtracting a TCP option size from the MSS. Thus, when the TCP option is used, the receiver 10 uses the value obtained by subtracting the TCP option size from the MSS, to determine the presence/absence of a subsequent segment.

In addition, it is also conceivable that, in a TCP communication, the presence/absence of a subsequent segment is determined based on the presence/absence of a PSH flag. The PSH flag is one type of TCP flag included in the TCP header. When a TCP data segment with a PSH flag is received, this indicates that the TCP data segment is to be promptly passed to a high-order protocol (e.g., the high-order application 13) without being buffered. A method for adding the PSH flag during TCP-data transmission is specified by RFC (Request for Comments). The use of the PSH flag to determine the presence/absence of a subsequent segment makes it possible to perform buffering with a short latency. However, there is a problem in that it takes time to perform buffering processing when the transfer of a data segment is delayed on the way as illustrated in FIG. 11 or when a PSH flag is implemented by the transmitter 20. The PSH flag depends on the implementation of the transmitter 20. Accordingly, in most implementations, a buffering method using the PSH flag is not currently employed, and the presence/absence of the PSH flag is not considered under the present circumstances.

Thus, in the embodiment, the determination of the presence/absence of a subsequent segment based on the PSH flag is not made. However, the determination of the presence/absence of a subsequent segment based on the PSH flag and the determination of the presence/absence of a subsequent segment based on the segment length in the embodiment may be performed in combination.

Next, a detailed description will be given of processing that is executed by the protocol handler 12 in order to realize the operational sequence illustrated in FIGS. 6 and 11.

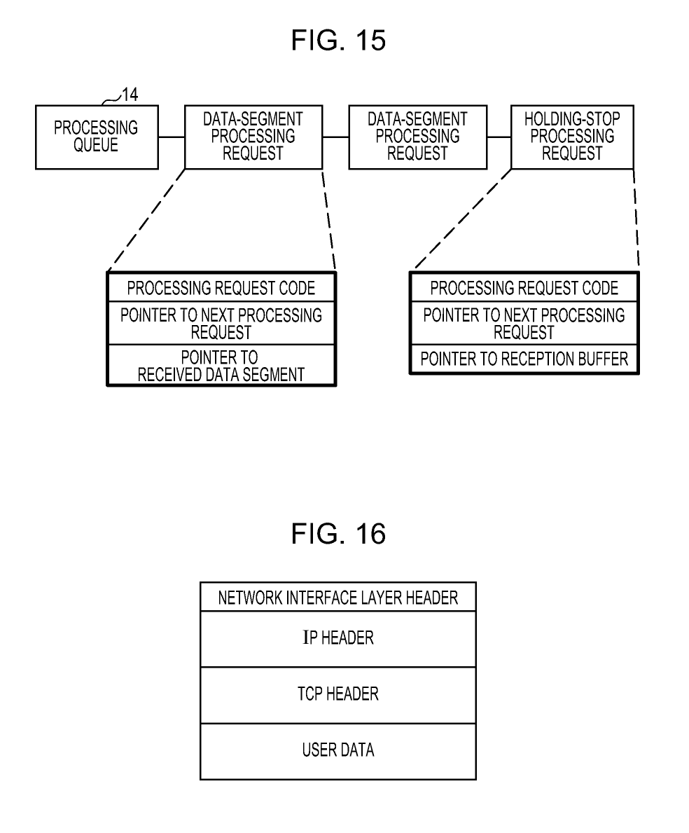

FIG. 14 is a diagram illustrating an example of an operational flowchart for receiving a data-segment processing request, according to a first embodiment.

In operation S201, upon receiving a data-segment processing request from the input-output controller 11 (YES in operation S201), the protocol handler 12 adds the received data-segment processing request to the end of the processing queue 14 (in operation S202).

FIG. 15 is a diagram illustrating an example of processing requests stored in a processing queue, according to a first embodiment. As described above, processing requests stored in the processing queue 14 have two types, namely, a data-segment processing request and a holding-stop processing request.

A data-segment processing request includes, for example, a processing-request code, a pointer to a next processing request, and a pointer to a data segment. The processing request code is code for identifying the type of processing request. With respect to the data-segment processing request, a value identifying a data-segment processing request is set as a processing request code. The pointer to the next processing request is a pointer (association information) to a next-term processing request that is to be processed next in the processing queue 14. The pointer to a data segment is a pointer to the actual entity of the data segment to be processed with respect to the data-segment processing request.

A holding-stop processing request includes a processing request code, a pointer to a next processing request, and a pointer to a reception buffer. The processing request code and the pointer to the next processing request are similar to the data-segment processing request, where a value identifying a holding-stop processing request is set as the processing request code. The pointer to the reception buffer is a pointer to a reception buffer 15 to be processed with respect to the holding-stop processing request. That is, the pointer to the reception buffer is a pointer to a reception buffer 15 associated with an application 13 to which the data segments stored in the reception buffer 15 are to be sent when the holding-stop processing request is set as a processing target.

A processing request added to the end of the processing queue 14 in operation S202 of FIG. 14 is a data-segment processing request. When the processing request added in operation S202 is referred to as a “processing request R” and a processing request at the end of the processing queue 14 before the processing request R is added thereto is referred to as a “processing request E”, the address of the processing request R may be set to the “pointer to the next processing request” in the processing request E. At the same time, for example, “null” representing an end or a tail is set to the “pointer to the next segment” in the processing request R. A pointer to a data segment received from the input-output controller 11 is set to the “pointer to the received data segment” in the processing request R. At this point, the received data segment may be configured, for example, as illustrated in FIG. 16.

FIG. 16 is a diagram illustrating an example of a received data segment before protocol processing is executed, according to an embodiment. As illustrated in FIG. 16, when a data-segment processing request associated with the received data segment is stored in the processing queue 14, that is, before the received data segment is subjected to the protocol processing, the received data segment contains, for example, a network interface layer header, an IP header, a TCP header, and user data.

The format of the network interface layer header depends on the type of physical network used. The user data is data that is meaningful to the application 13.

Next, a description will be given of an operational sequence that is executed by the protocol handler 12 in response to a processing request stored in the processing queue 14.

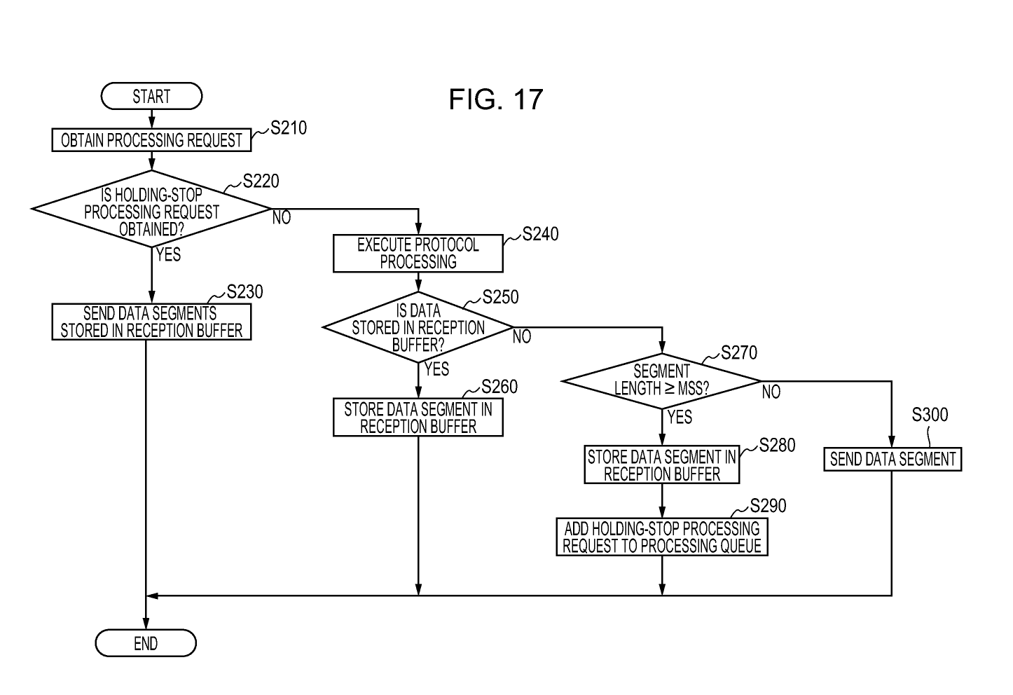

FIG. 17 is a diagram illustrating an example of an operational flowchart for processing a processing request, according to a first embodiment.

In operation S210, the protocol handler 12 obtains a processing request at the head of the processing queue 14.

In operation S220, the protocol handler 12 refers to the processing request code in the obtained processing request to determine whether or not the obtained processing request (hereinafter referred to as a “target processing request”) is a holding-stop processing request. When the target processing request is a holding-stop processing request (YES in operation S220), the process proceeds to operation S230.

In operation S230, the protocol handler 12 sends, to the application 13 that is the destination associated with the reception buffer 15, the data segment(s) stored in the reception buffer 15 identified by the “pointer to the reception buffer” in the holding-stop processing request.

On the other hand, when the target processing request is a data-segment processing request (NO in operation S220), the process proceeds to operation S240.

In operation S240, the protocol handler 12 executes, as a predetermined processing, protocol processing on the received data segment identified by the “pointer to the received data segment” in the target processing request. In the protocol processing, the TCP option size is also determined. The received data segment identified by the “pointer to the received segment” in the target processing request is hereinafter referred to as a “target data segment”.

In operation S250, the protocol handler 12 determines whether or not one or more data segments are stored in the reception buffer 15 associated with the destination of the target data segment. When one or more data segments are stored in the reception buffer 15 (YES in operation S250), the protocol handler 12 stores, in the reception buffer 15, the target data segment on which the protocol processing has been executed, in operation S260.

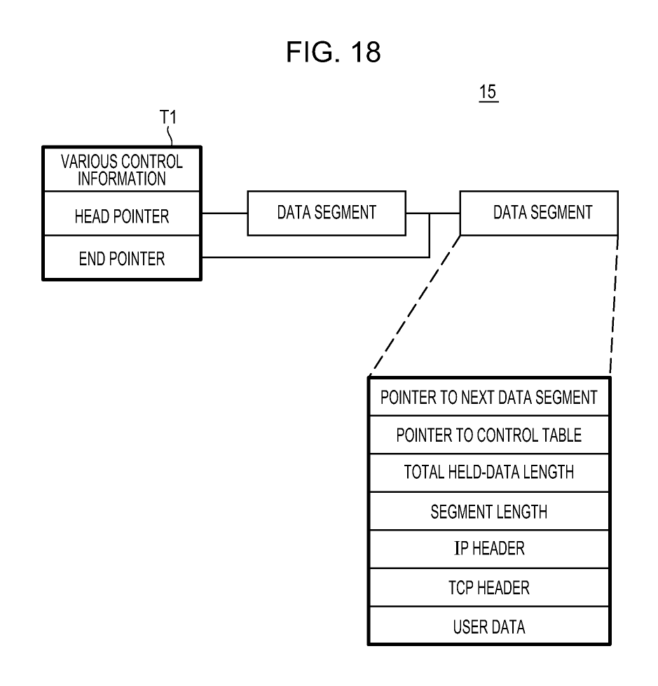

FIG. 18 is a diagram illustrating an example of a reception buffer, according to an embodiment. Each reception buffer 15 has a control table T1 therein. The control table T1 stores, for example, various control information, a head pointer, and an end pointer. Examples of the various control information include a corresponding destination (a port number). The head pointer is a pointer to a data segment at the head of the reception buffer 15. The end pointer is a pointer to a data segment at the end of the reception buffer 15.

Each data segment includes a pointer to a next data segment, a pointer to the control table, a total held-data length, a segment length, an IP header, a TCP header, and user data. As is apparent by comparison with FIG. 16, the pointer to the next data segment, the pointer to the control table, the total held-data length, and the segment length are pieces of information to be given by the protocol handler 12 during the protocol processing or when the each data segment is stored in the reception buffer 15.

The pointer to the next data segment is a pointer to a next data segment within the reception buffer 15. The pointer to the control table is a pointer to the control table T1 in the reception buffer 15. The total held-data length is a total of the lengths of all the data segments stored in the reception buffer 15. The total held-data length may be effective only for the data segment at the head of the reception buffer 15. The segment length is the length of the data segment.

Thus, in operation S260, the pointer to the target data segment is set to the “pointer to the next data segment” in a data segment identified by the end pointer held in the control table T1 in the reception buffer 15 associated with the destination of the target data segment. Further, null representing an end or a tail is set to the “pointer to the next data segment” in the target data segment. The length of the target data segment is added to the total held-data length in the data segment identified by the head pointer in the control table T1. In addition, the pointer to the target data segment is set to the end pointer in the control table T1.

On the other hand, when the reception buffer 15 associated with the destination of the target data segment is empty (NO in operation S250 of FIG. 17), the process proceeds to operation S270.

In operation S270, the protocol handler 12 determines whether or not the length of the target data segment is larger than or equal to the MSS. When the TCP option size is larger than 0, the length of the target data segment is compared with a value obtained by subtracting the TCP option size from the MSS, that is, a value of “MSS-TCP option size”.

When the length of the target data segment is larger than or equal to the MSS (YES in operation S270), the process proceeds to operation S280.

In operation S280, the protocol handler 12 stores the target data segment in the reception buffer 15 associated with the destination of the target data segment.

In operation S290, the protocol handler 12 adds a holding-stop processing request to the end of the processing queue 14, where a pointer to the reception buffer 15 associated with the destination of the target data segment is set to the “pointer to the reception buffer” in the holding-stop processing request.

On the other hand, when the length of the target data segment is smaller than the MSS (NO in operation S270), the process proceeds to operation S300.

In operation S300, the protocol handler 12 sends the target data segment on which the protocol processing has been executed, to the application 13 that is the destination of the target data segment. Thus, the target data segment is not stored in the reception buffer 15.

According to the operations illustrated in FIG. 17, when a previously received data segment is stored in the reception buffer 15 associated with the destination of the target data segment (YES in operation S250), the target data segment on which the protocol processing has been executed is stored in the reception buffer 15 regardless of whether or not the length of the target data segment is smaller than the MSS, for the following reason. Regardless whether or not the length of the target data segment is smaller than the MSS when a previously received data segment is stored in the reception buffer 15, the reception buffer 15 will be eventually cleared, that is, the data segments stored in the reception buffer 15 will be sent out, in response to a holding-stop processing request. In other words, even if the reception buffer 15 is cleared (the data segments stored in the reception buffer 15 are sent out) because the length of the target data segment is smaller than the MSS when a previously received data segment is stored in the reception buffer 15, the effect of reducing the number of processing operations is deemed to be small. Further, since the length of the target data segment and the MSS need to be compared with each other, the number of processing operations may increase.

As described above, according to the first embodiment, in the case where the reception buffer 15 associated with the destination of a target data segment is empty when a data-segment processing request for the target data segment is processed, a holding-stop processing request is added to the end (tail) of the processing queue 14. Meanwhile, data segment(s) associated with data-segment processing request(s) are stored in the reception buffer 15 until the holding-stop processing is executed as a processing target, and when the holding-stop processing request is executed as a processing target, the data segment(s) that have been stored in the reception buffer 15 after adding the holding-stop processing request to the processing queue 14 are sent, at once, to the application 13 that is the destination thereof.

As a result, it is possible to relax reduction in responsiveness due to elapse of a certain amount of time or due to the buffering of a certain length of data. It is also possible to prevent the occurrence of frequent data segment passing between the protocol handler 12 and the application 13, thereby reducing overhead due to the passing of data segments.

A second embodiment will be described next. Points that are different from those in the first embodiment will be described in the second embodiment. Thus, points that are not particularly stated hereinafter may be the same as or similar to those in the first embodiment.

In the first embodiment described above, a data segment whose length is larger than or equal to the MSS is buffered. However, when no subsequent data segments exist after the data segment whose length is larger than or equal to the MSS is buffered, that is, when multiple data segments are not sent out at once after the buffering processing, time used for buffering the data segments is wasted. Such a situation may occur, for example, when the transfer speed of the network is lower than a speed at which the receiver 10 processes the data segments, as in the case illustrated in FIG. 11.

Accordingly, in the second embodiment, the protocol handler 12 is adapted so as not to perform buffering processing for a certain time period with respect to the reception buffer 15 (the connection) for which an event in which only one data segment is sent at once to the application 13 has continuously occurred a predetermined number of times or more. When the network load decreases after the certain amount of time elapses and it is expected the advantage of the buffering is obtained, the protocol handler 12 resumes the buffering processing.

Since control of the processing described above is performed for each destination (connection), it is possible to individually deal with difference in line-speeds caused by difference in communication destinations.

A description will be given of processing that is executed by the protocol handler 12 in order to realize the control of the processing described above.

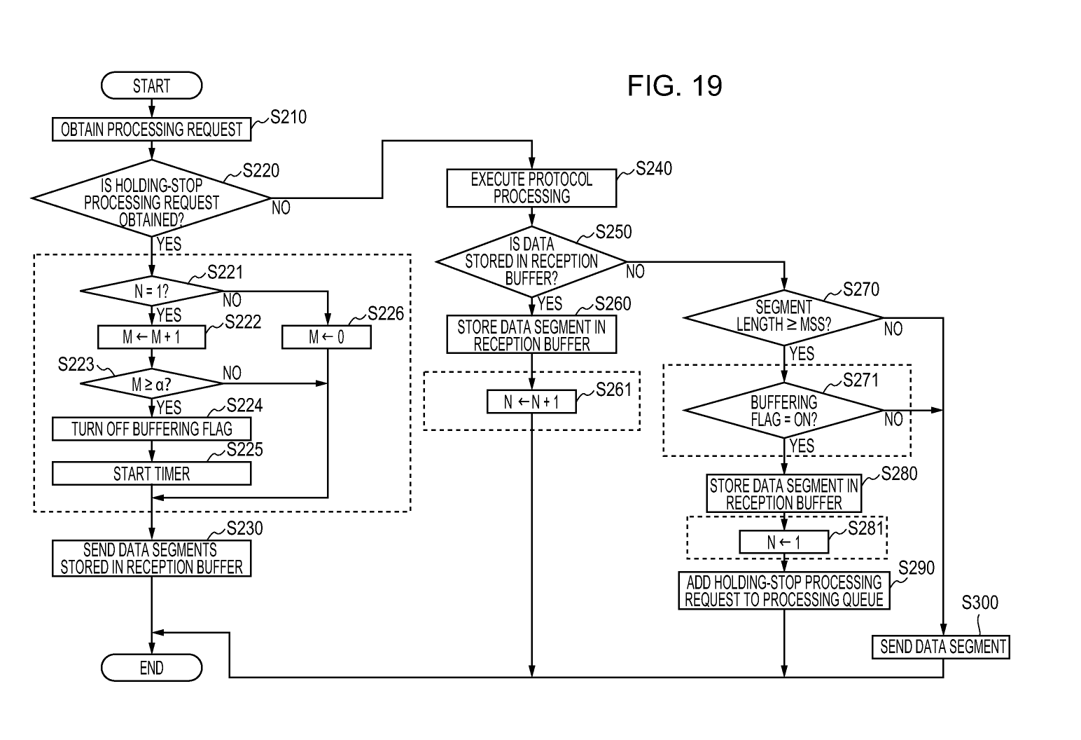

FIG. 19 is a diagram illustrating an example of an operational flowchart for processing a processing request, according to a second embodiment. In FIG. 19, operations that are substantially the same as those in FIG. 17 are denoted by the same reference characters, and descriptions thereof are not given hereinafter. In FIG. 19, subsequent to operation S260, operation S261 is executed.

In operation S261, the protocol handler 12 adds 1 to a variable N, where the variable N holds the number of data segments stored in the reception buffer 15 associated with the destination of the target data segment. The variable N is hereinafter referred to as “holding count N”. Upon initiation of a connection, the value of the holding count N is initialized to “0”. The holding count N may be managed, for example, in the control table T1 in the reception buffer 15.

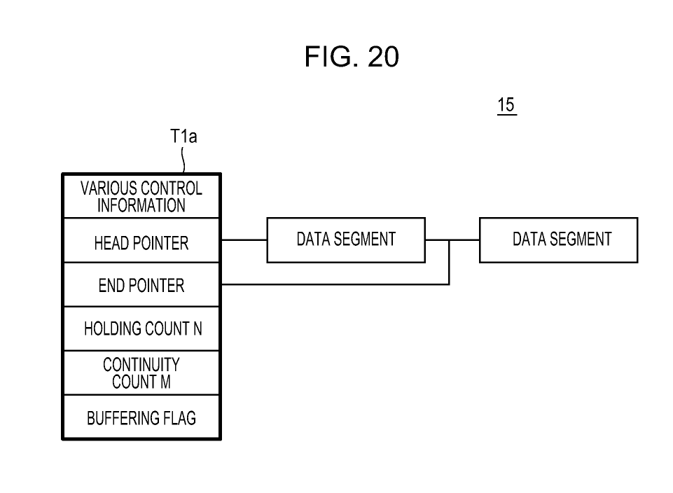

FIG. 20 is a diagram illustrating an example of a reception buffer, according to a second embodiment. In FIG. 20, the same portions as those in FIG. 18 are not described hereinafter.

A control table T1a in the second embodiment further includes a holding count N, a continuity count M, a buffering flag, in addition to the various control information, the head pointer, and the end pointer. The holding count N holds the number of data segments stored in the reception buffer 15 associated with the destination of the target data segment, as described above. The continuity count M represents the number of continuous occurrences of an event in which only one data segment is sent at once to the application 13 in a state of the holding count N being “1”. That is, the continuity count M represents the number of continuous occurrences of an event in which only one data segment is sent at once to the application 13 when the number of buffered data segment is “1”. The initial value of the continuity count M is “0”. The buffering flag represents a flag variable indicating whether or not buffering is to be performed. The initial value of the buffering flag is “ON” where value “ON” indicates that buffering is to be performed and value “OFF” indicates that buffering is not to be performed.

In FIG. 19, when the target processing request is a holding-stop processing request (YES in operation S220), operations S221 to S226 are executed before operation S230 is executed.

In operation S221, the protocol handler 12 determines whether the value of the holding count N in the control table T1a in the reception buffer 15 is “1” or not, where the reception buffer 15 is identified by the “pointer to the reception buffer” in the holding-stop processing request that is the target processing request. That is, the protocol handler 12 determines whether the number of data segments stored in the reception buffer 15 is “1” or not. Hereinafter, this reception buffer 15 and this control table T1a will be referred to as “target reception buffer 15” and “target control table T1a”, respectively.

When the holding count N is “1” (YES in operation S221), the protocol handler 12 adds “1” to the continuity count M in operation S222.

In operation S223, the protocol handler 12 determines whether or not the continuity count M is larger than or equal to a threshold a. The threshold a specifies a threshold value for stopping the buffering such that the buffering is stopped when an event in which only one data segment is sent at once to the application 13 in a state of the number of buffered data segment being “1” has continuously occurred the threshold a times. For example, “10” may be set as the threshold α.

When the continuity count M is larger than or equal to the threshold a (YES in operation S223), the process proceeds to operation S224.

In operation S224, the protocol handler 12 turns off the buffering flag in the target control table T1a. That is, a value indicating that no buffering is to be performed on the target reception buffer 15 is set to the buffering flag.

In operation S225, the protocol handler 12 starts a timer. The term “timer” as used hereinafter refers to a timer for measuring a certain amount of time period during which the buffering flag is kept OFF. When the certain amount of time period elapses, the timer issues, to the protocol handler 12, a notification indicating that the certain amount of time period has elapsed. In response to the notification from the timer, the protocol handler 12 restores the value of the buffering flag to ON. This allows the protocol handler 12 to avoid falling into a state in which buffering is not performed indefinitely. Even after the buffering flag is kept OFF for the certain amount of time period, the continuity count M in the target control table T1a is not initialized. Therefore, after the buffering flag is restored to ON in response to the notification from the timer, when operation S221 is executed in a state of the holding count N being “1”, the buffering flag is immediately turned OFF at operation S224.

On the other hand, when the holding count N in the target control table T1a is not “1” (NO in operation S221), the process proceeds to operation S226.

In operation S226, the protocol handler 12 initializes the continuity count M in the target control table T1a to “0”. This is because multiple data segments are stored in the target reception buffer 15 and, in subsequent operation S230, the multiple data segments are sent at once to the application 13 that is the destination thereof.

Subsequent to operation S226 or when the result of the determination in operation S223 is NO, the protocol handler 12 executes operation S230.

Further, in FIG. 19, when the result of the determination in S270 is YES, operation S271 is executed.

In operation S271, the protocol handler 12 determines whether the buffering flag in the target control table T1a is ON or not. When the buffering flag is ON (YES in operation S271), the protocol handler 12 executes operations S280 and S290. When the buffering flag is OFF (NO in operation S271), the protocol handler 12 executes operation S300 in which the target data segment is sent to the application 13 that is the destination thereof without being stored in the target reception buffer 15.

In FIG. 19, subsequent to operation S280, operation S281 is further executed.

In operation S281, the protocol handler 12 sets the holding count N at “1”.

As described above, according to the second embodiment, when multiple segments are not received at once, for example, due to the high network load, ineffective performance of the buffering processing may be avoided, thereby improving the processing efficiency.

In the above, description has been given of an example in which the buffering processing is not performed for a certain amount of time period when an event in which data stored in the reception buffer 15 are sent out in a state of the holding count N being “1” has continuously occurred a predetermined number of times. However, the condition of the holding count N being “1” may be replaced with a condition of the holding count N being smaller than or equal to a predetermined value (e.g., “2”). That is, when an event in which data stored in the reception buffer 15 are sent out in a state of the holding count N being smaller than or equal to the predetermined value has continuously occurred a predetermined number of times, the buffering processing is not performed for a certain amount of time period.

A third embodiment will be described next. Points that are different from those in the second embodiment will be described in the third embodiment. Thus, points that are not particularly stated hereinafter may be the same as or similar to those in the second embodiment.

When the length of a data segment associated with a data-segment processing request processed immediately before a holding-stop processing request is larger than or equal to the MSS, there is a possibility that the data segment has a subsequent data segment. Accordingly, in such a case, the protocol handler 12 in the third embodiment moves the holding-stop processing request to the end of the processing queue 14 without executing processing for the holding-stop processing request.

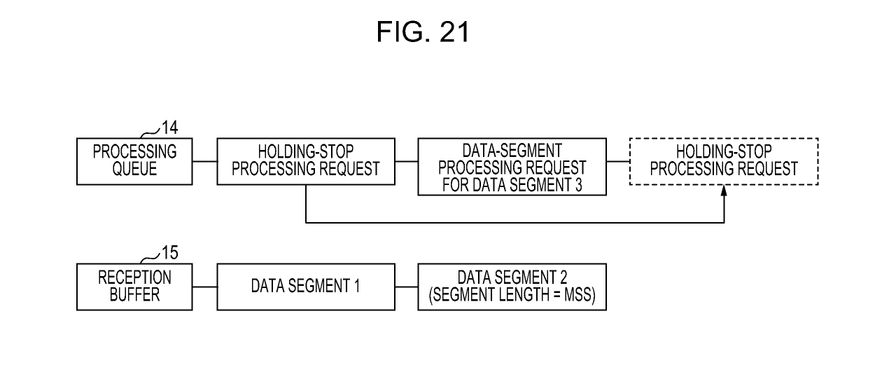

FIG. 21 is a diagram illustrating an example of states of a processing queue and a reception buffer, according to a third embodiment. FIG. 21 illustrates a case in which a holding-stop processing request is moved to the end of the processing queue without being processed. In the example of FIG. 21, when a holding-stop processing request is set as a processing target, the length of a data segment 2 associated with a data-segment processing request processed immediately before the holding-stop processing request matches the MSS. In such a case, the protocol handler 12 moves the holding-stop processing request to the end of the processing queue 14. With this arrangement, for example, when a data-segment processing request for a data segment 3 that is a subsequent data segment of the data segment 2 is stored immediately after the holding-stop processing request in the processing queue 14 as illustrated in FIG. 21, the processing efficiency may be improved. That is, when processing the moved holding-stop processing request, the data segment 1, the data segment 2, and the data segment 3 may be sent at once to the application 13 that is the destination thereof.

However, when the total length of all of the data segments stored in the reception buffer 15 is larger than or equal to a predetermined value or when the total number of data segments stored in the reception buffer 15 is larger than or equal to a predetermined number, the protocol handler 12 does not move the holding-stop processing request. That is, in such a case, all of the data segments stored in the reception buffer 15 are immediately sent to the application 13 that is the destination of the received segments. This may prevent the reception buffer 15 from being exhausted.

Next, a description will be given of processing that is executed by the protocol handler 12 in order to realize the processing control mentioned above.

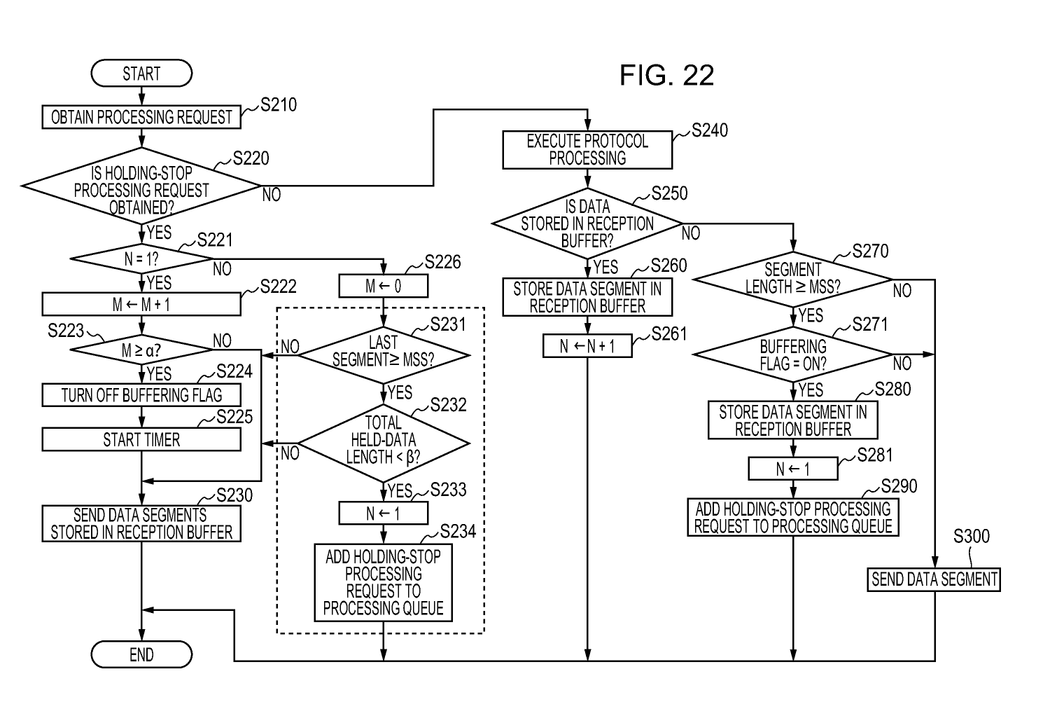

FIG. 22 is a diagram illustrating an example of an operational flowchart for processing a processing request, according to a third embodiment. In FIG. 22, operations that are substantially the same as those in FIG. 19 are denoted by the same reference characters, and descriptions thereof are not given here.

In FIG. 22, subsequent to operation S226, operations S231 to S234 are executed.

In operation S231, the protocol handler 12 determines whether or not the length of a data segment identified by the end pointer in the target control table T1a is larger than or equal to the MSS. This data segment is associated with a data-segment processing request processed immediately before the holding-stop processing request currently set as a processing target. This data segment is hereinafter referred to as a “last data segment”. Here, when the TCP option size is not “0”, the length of the last data segment may be compared with a value of “MSS-TCP option size”.

When the length of the last data segment is larger than or equal to the MSS (YES in operation S231), the process proceeds to operation S232.

In operation S232, the protocol handler 12 determines whether or not the total length of all of the data segments stored in the target reception buffer 15 is smaller than a predetermined value β. The predetermined value β may be set at a value within which the reception buffer 15 is not exhausted, in accordance with the size of the reception buffer 15. For example, 64 kilobytes may be set as the predetermined value β. In operation S232, a determination may also be made as to whether or not the total number of data segments stored in the target reception buffer 15 is smaller than or equal to a predetermined number.

When the total length is smaller than the predetermined value β (YES in operation S232), the protocol handler 12 sets the holding count N at “1” in operation S233.

In operation S234, the protocol handler 12 adds a holding-stop processing request to the end of the processing queue 14. As a result, the holding-stop processing request set as a processing target is moved to the end of the processing queue 14.

Here, it is noted that operation S230 is not executed subsequently to operation S234.

Meanwhile, when the length of the last data segment is smaller than the MSS (NO in operation S231) or when the total length of the data segments is larger than or equal to the predetermined value β (NO in operation S232), operation S230 is executed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method for processing received data, the method being performed by a communication apparatus, the method comprising:
upon receiving a first data segment, storing, in a processing queue, a data-segment processing request associated with the first data segment;
performing, when the data-segment processing request is extracted from the processing queue, predetermined processing on the first data segment associated with the data-segment processing request to generate a second data segment; and
storing the generated second data segment in a reception buffer provided for each of destinations of data segments, wherein
a holding-stop processing request is stored in the processing queue when the second data segment is stored in the reception buffer being empty, and
all of one or more second data segments stored in the reception buffer are sent at once to a destination associated with the reception buffer when the holding-stop processing request is extracted from the processing queue.

2. The method of claim 1, further comprising
setting a maximum size of the first data segment, based on a communication protocol used by the communication apparatus, wherein
the second data segment generated from the first data segment having the maximum size is sent to the destination associated with the reception buffer without being stored in the reception buffer.

3. The method of claim 1, further comprising
detecting an event in which a number of the second data segments stored in the reception buffer is a natural number not exceeding a predetermined constant value when the holding-stop processing request is extracted from the processing queue, wherein
when the event has continuously occurred predetermined times, the generated second data segment is sent to the destination associated with the reception buffer without being stored in the reception buffer, for a certain time period.

4. The method of claim 1, further comprising
setting a maximum size of the first data segment, based on a communication protocol used by the communication apparatus, wherein
when the second processing request is extracted from the processing queue just after the data-segment processing request associated with the first data segment having the maximum size has been extracted from the processing queue, the extracted second processing request is added to the processing queue without sending one or more second data segments stored in the reception buffer to the destination associated with the reception buffer.

5. An apparatus for processing received data, the apparatus comprising:
a memory including:
a processing queue for storing, upon receiving a first data segment, a data-segment processing request associated with the first data segment, and
a reception buffer provided for each of destinations of data segments; and
a processor to:
store, in the processing queue, the data-segment processing request associated with the first data segment received by the apparatus, in order in which the first data segment is received by the apparatus;
perform, when the data-segment processing request is extracted from the processing queue, predetermined processing on the first data segment associated with the first processing request to generate a second data segment; and
store the generated second data segment in the reception buffer, wherein
a holding-stop processing request is stored in the processing queue when the second data segment is stored in the reception buffer being empty, and
all of one or more second data segments stored in the reception buffer are sent at once to a destination associated with the reception buffer when the holding-stop processing request is extracted from the processing queue.

6. The apparatus of claim 5, wherein
a maximum size of the first data segment is set based on a communication protocol used by the apparatus, and
the second data segment generated from the first data segment having the maximum size is sent to the destination associated with the reception buffer without being stored in the reception buffer.

7. The apparatus of claim 5, wherein
the processor is configured to detect an event in which a number of the second data segments stored in the data-segment queue does not exceeds a predetermined constant value when the holding-stop processing request is extracted from the processing queue, and
when the event has continuously occurred predetermined times, the generated second data segment is sent to the destination associated with the reception buffer without being stored in the reception buffer, for a certain time period.

8. The apparatus of claim 5, wherein
the processor is configured to set a maximum size of the first data segment, based on a communication protocol used by the communication apparatus; and
when the second processing request is extracted from the processing queue just after the data-segment processing request associated with the first data segment having the maximum size has been extracted from the processing queue, the extracted second processing request is added to the processing queue without sending one or more second data segments stored in the reception buffer to the destination associated with the reception buffer.

9. A computer readable recording medium having stored therein a program for causing a computer to execute a procedure comprising:
upon receiving a first data segment, storing, in a processing queue, a data-segment processing request associated with the first data segment;
performing, when the data-segment processing request is extracted from the processing queue, predetermined processing on the first data segment associated with the data-segment processing request to generate a second data segment; and
storing the generated second data segment in a reception buffer provided for each of destinations of data segments, wherein
a holding-stop processing request is stored in the processing queue when the second data segment is stored in the reception buffer being empty, and
all of one or more second data segments stored in the reception buffer are sent at once to a destination associated with the reception buffer when the holding-stop processing request is extracted from the processing queue.

10. The computer readable recording medium of claim 9, the procedure further comprising
setting a maximum size of the first data segment, based on a communication protocol used by the communication apparatus, wherein
the second data segment generated from the first data segment having the maximum size is sent to the destination associated with the reception buffer without being stored in the reception buffer.

11. The computer readable recording medium of claim 9, the procedure further comprising
detecting an event in which a number of the second data segments stored in the reception buffer is a natural number not exceeding a predetermined constant value when the holding-stop processing request is extracted from the processing queue, wherein
when the event has continuously occurred predetermined times, the generated second data segment is sent to the destination associated with the reception buffer without being stored in the reception buffer, for a certain time period.

12. The computer readable recording medium of claim 9, the procedure further comprising
setting a maximum size of the first data segment, based on a communication protocol used by the communication apparatus, wherein
when the second processing request is extracted from the processing queue just after the data-segment processing request associated with the first data segment having the maximum size has been extracted from the processing queue, the extracted second processing request is added to the processing queue without sending one or more second data segments stored in the reception buffer to the destination associated with the reception buffer.
